(19) United States
(12) Patent Application Publication
(10) Pub. No.: US 2004/0149108 A1
(43) Pub. Date: Aug. 5, 2004

(54) Craft trimmer assembly

(75) Inventors: Mark A. McLean, Wausau, WI (US); William J. Schulz, Mosinee, WI (US); Jason Wolf, Wausau, WI (US)

Correspondence Address: FOLEY & LARDNER, 321 NORTH CLARK STREET, SUITE 2800, CHICAGO, IL, 60610-4764, US

(73) Assignee: Fiskars Brands, Inc.

(21) Appl. No.: 10/763,892

(22) Filed: Jan. 23, 2004

Related U.S. Application Data
(60) Provisional application No. 60/442,245, filed on Jan. 24, 2003.

(51) Int. Cl. B26D 1/18

(52) U.S. Cl. 83/614; 83/485

(57) ABSTRACT

An improved craft trimmer assembly for cutting material such as paper and card stock. The improved craft trimmer assembly includes a cartridge assembly that is removably connected to a base. The cartridge assembly comprises a cartridge and a sleigh, with a blade fitting within the cartridge. The improved craft trimmer also includes a measuring arm that is rotatably connected to the bottom of the craft trimmer board. The measuring arm includes a raised surface which aligns flush with an interchangeable plate on the top of the craft trimmer board.

The present application claims priority to U.S. Provisional Patent Application No. 60/442,245, filed Jan. 24, 2003.

### FIELD OF THE INVENTION

The present invention relates generally to craft trimmer assemblies. More particularly, the present invention relates to an improved craft trimmer assembly which provides the user with an easier method of using and manipulating the assembly.

### BACKGROUND OF THE INVENTION

A variety of paper trimmer assemblies and craft trimmer assemblies are conventionally known. Several conventional assemblies generally comprise a base having a flat upper surface, along with a blade carriage which slidably moves along the flat upper surface. Such craft trimmer assemblies also occasionally include one or more rotatable measuring arms that can be used to make particular measurements of the material that is to be cut.

Although such trimmers are conventionally known, most such trimmers suffer from a number of drawbacks. For example, conventional trimmers with rotatable measuring arms have the measuring arms coupled to the bottom of the base of the craft trimmer. As a result, the top surface of the measuring arm is not flush with the flat surface of the base. This can result in difficulties in accurately aligning, measuring and cutting the material in question, since the material to be cut will not be firmly resting on a single surface and is more susceptible to accidental movement. Furthermore, conventional craft trimmers that include a blade carriage slidably mounted on the flat surface of the base are fixedly attached to the base. When a user needs to replace the blade inside the blade carriage, the user is required to disassemble part of the blade carriage while the carriage remains on the base. This can result in a significant amount of difficulty in disassembling the blade carriage, removing the old blade from the blade carriage, inserting a new blade and reassembling the blade carriage without damaging any of the individual components.

For all of these reasons, it would be desirable to develop an improved craft trimmer assembly that overcomes these shortcomings and results in a craft trimmer which is easier to use and minimizes the risk of damage to the individual component and errors in the alignment and cutting of the materials in question.

### SUMMARY OF THE INVENTION

It is therefore an object of the invention to provide an improved craft trimmer assembly that allows for an easier method of removing and replacing the cutting blade from the blade cartridge.

It is another object of the invention to provide an improved craft trimmer assembly that allows the material to rest firmly on the base of the trimmer with a minimal amount of potential movement and/or misalignment.

It is yet another object of the invention to provide an improved craft trimmer assembly that includes a removable blade cartridge.

It is still another object of the present invention to provide an improved craft trimmer assembly that minimizes the amount of potential misalignment and provides for a substantially straightened cut.

In accordance with the above objects, a craft trimmer assembly is provided comprising a cutting board with a cartridge assembly slidably connected thereto. The cartridge assembly includes a cartridge which is removable from the rest of the craft trimmer, permitting a user to easily remove and replace the cutting blade from the cartridge. The craft trimmer assembly includes a measuring arm that is rotatably connected to the bottom of the craft trimmer. A portion of the measuring arm is substantially flush with the flat surface of a cutting mat on the craft trimmer assembly, resulting in the material to be cut being substantially flat during the cutting process. The craft trimmer assembly also includes a removable paper clamp that is used to both align and fix the position of the material to be cut. The craft trimmer assembly may also include removable cutting plates having a plurality of different indicia to aid in the cutting and aligning processes.

These and other objects, advantages and features of the invention, together with the organization and manner of operation thereof, will become apparent from the following detailed description when taken into conjunction with the accompanying drawings, wherein like elements have like numerals throughout the several drawings described below.

### BRIEF DESCRIPTION OF THE DRAWINGS

FIG. 1 is a perspective view of a craft trimmer assembly constructed according to the present invention, with the paper clamp and interchangeable plate separated from the remainder of the assembly;

FIG. 2 is a top view of a craft trimmer assembly constructed according to the present invention;

FIG. 3 is a front end view of the craft trimmer assembly of FIG. 2;

FIG. 4 is an exploded perspective view of the craft trimmer assembly of FIG. 2;

FIG. 5A shows an interchangeable plate with ½″ guidelines; FIG. 5B shows an interchangeable plate with angle guidelines; and FIG. 5C shows an interchangeable plate with ⅛″ guidelines;

FIG. 6 is a perspective view of the cartridge and sleigh of the blade cartridge assembly; and

FIG. 7 is an exploded view of the cartridge.

### DETAILED DESCRIPTION OF THE INVENTION

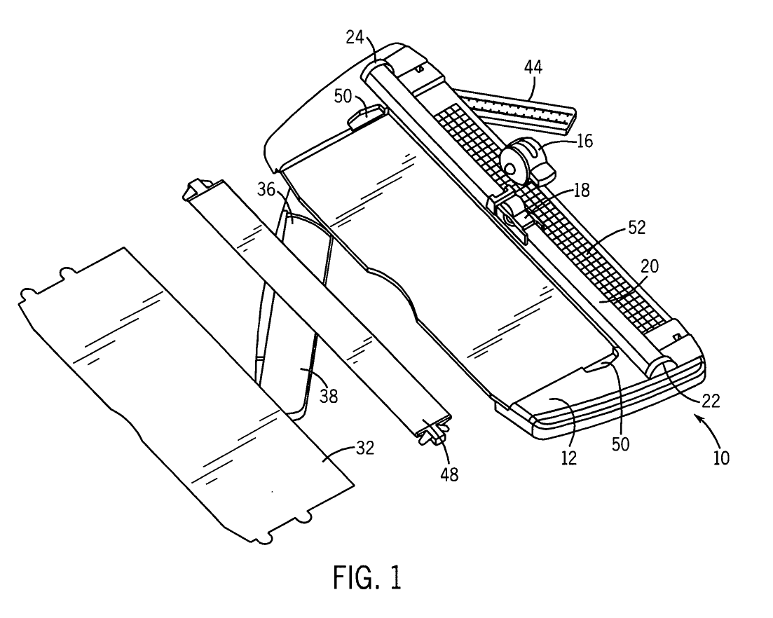

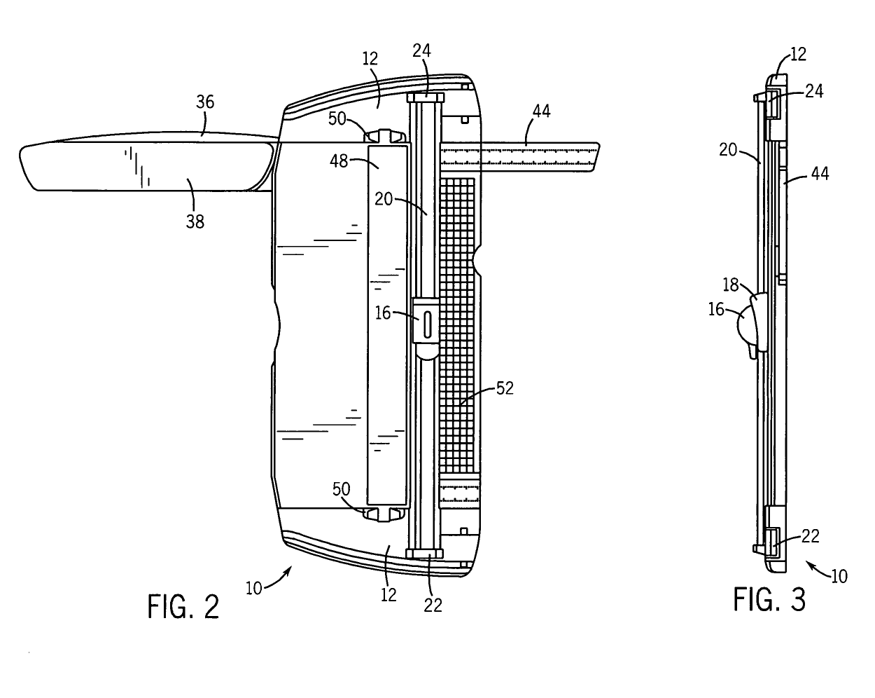

A craft trimmer assembly constructed according to the present invention is shown generally at 10 in FIGS. 1-4. The craft trimmer assembly 10 comprises a base 12 and a blade cartridge assembly 14 removably attached thereto. The blade cartridge assembly 14 comprises a cartridge 16 removably mounted on a sleigh 18, as shown in FIG. 7. The sleigh 18 slidably moves along a rail 20. The rail 20 is mounted on first and second hinge portions 22 and 24, respectively. The cartridge 16 includes a blade 26 removably positioned on the inside thereof. The blade cartridge assembly 14 is positioned within the craft trimmer assembly 10 such that the blade 26 aligns with a cutting mat 28 that fits within the base 12. The cutting mat 28 enables an improved cutting performance and is easy to replace, extending the life of the craft trimmer assembly 10.

By having the cartridge 16 removably connected to the sleigh 18, the user is able to quickly separate the cartridge 16 from the sleigh 18 and remove and replace the cutting blade 26. In conventional craft trimmers, the cartridge assembly comprises a single component which must be disassembled, often through the use of the tools. This can be an extraordinarily cumbersome process and can also result in potential damage to the cartridge assembly. In the present invention, however, the cartridge 16 simply snap fits onto the sleigh 18, resulting in an easy method for removing the cartridge 16 in order to effectuate blade replacement and also extending the life of the overall craft trimmer assembly 10. This arrangement also permits different types of blades 26 to be used with the cartridge assembly 14. In one embodiment of the invention, three 28 mm blades could be used—a straight blade, a scoring blade and a perforated blade. The user also has the ability to switch between cutting and scoring patterns quickly and easily. Furthermore, blades 26 with patterns such as wave patterns, in addition to pinking and deckle blades, may also be used.

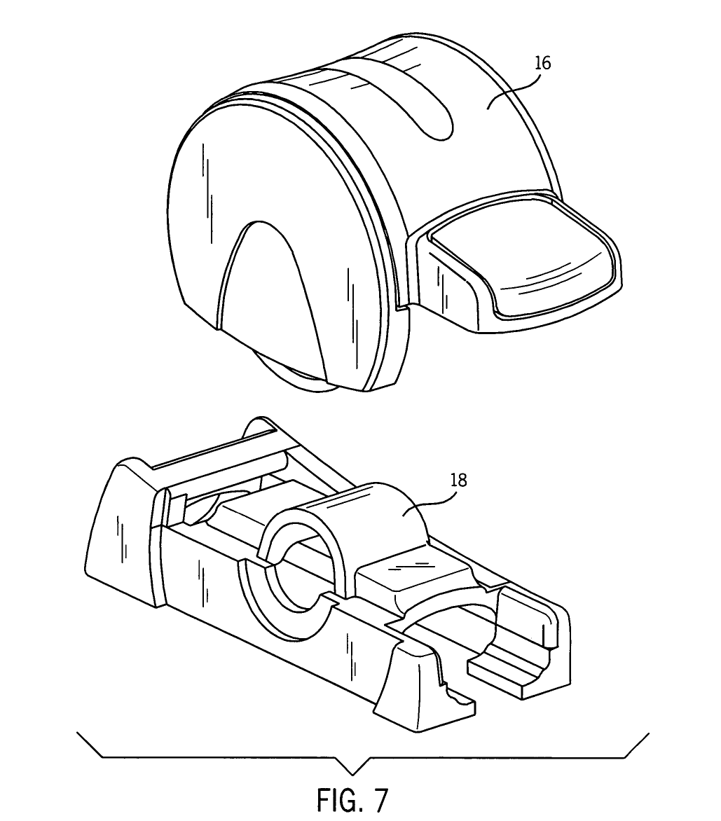

As shown in FIG. 6, the cartridge 16 comprises an assembly of separate parts for retaining a blade 26 that can be straight, perforating, or any other patterned blade. The blade 26 is pressed onto an axle 54 and becomes permanently attached thereto. A square hole in the blade 26 causes the blade 26 and the axle 54 to rotate as one unit on a top casing 52 and a side casing 53. This prevents the need for having a hardened axle to allow the blade 26 to rotate on. A coupling member 55 causes the axle 54 and the blade 26 to be pressed against the rail 20 and maintain an accurate cut. The axle 54 also acts as a latch to keep the cartridge 16 from falling off the sleigh 18 when the hinge portions 22 and 24 are rotated open to allow positioning of the material. There is also an area to mark the cartridge 16 and indicate the blade type. A biasing member in the form of a spring 56 actuates against the sleigh 18 and keeps the blade 26 in a protected position when the carriage 16 is attached to the sleigh 18 and the rail 20.

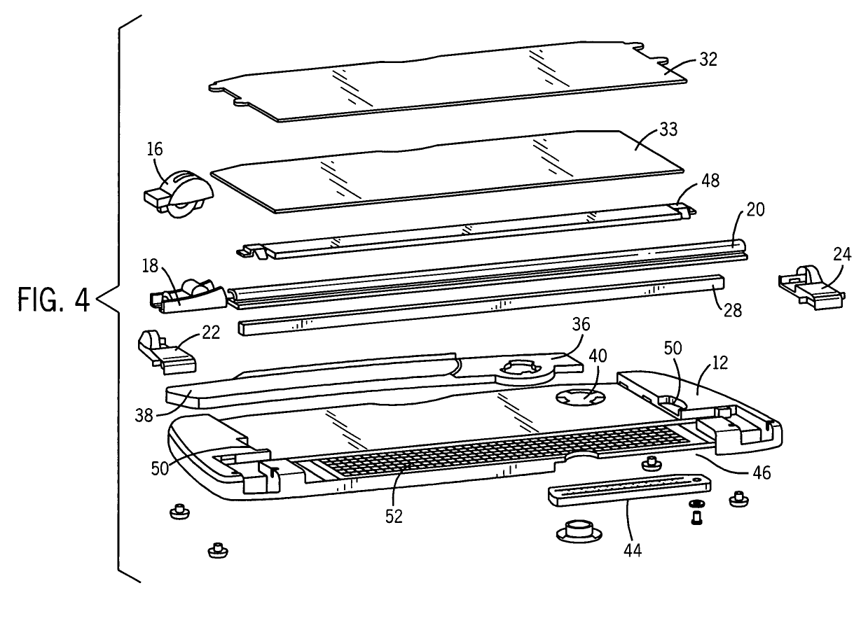

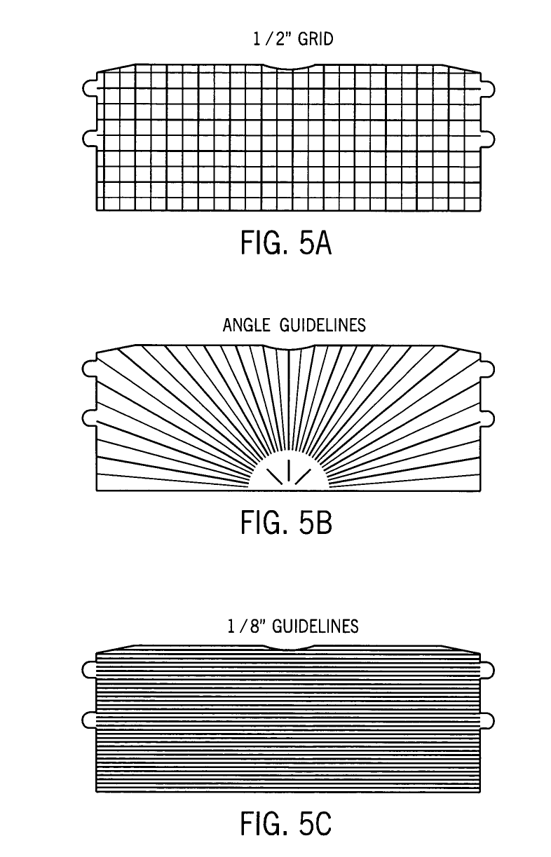

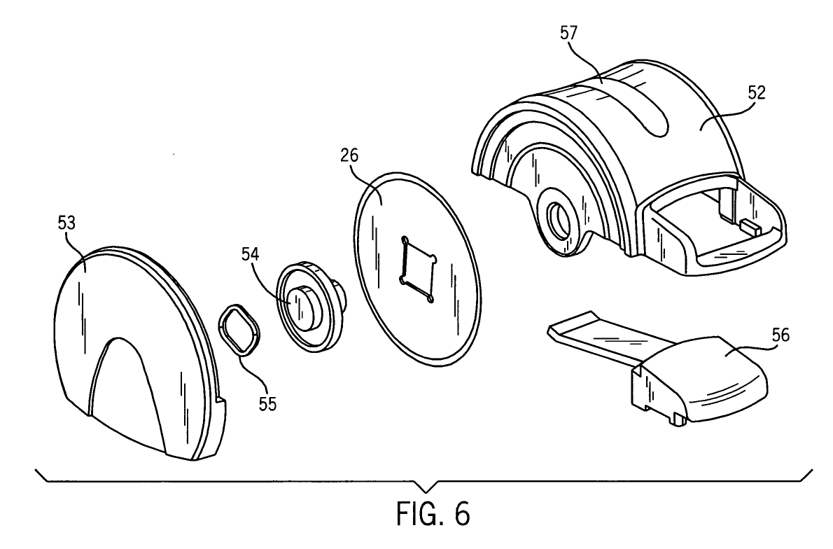

As shown in FIG. 4, the base 12 preferably includes a veneer board 33 that fits on the top surface thereof. In a preferred embodiment of the invention, one of several removable plates 32 may fit on top of the craft trimmer base 12. The interchangeable plates 32 can include several different graphic indicia thereon. These indicia can provide information such as the size of particular standardized sheets of paper, business size envelopes, etc. In an alternate embodiment of the invention, a single, nonremovable plate could also be used. Three types of interchangeable plates 32 are shown in FIGS. 5A-5C. The interchangeable plate 32 shown in FIG. 5A shows ½″ grid lines. Common photograph and card sizes may also be included. The interchangeable plate 32 shown in FIG. 5B includes angle guidelines. The interchangeable plate 32 shown in FIG. 5C includes ⅛″ guidelines.

As shown in FIGS. 1-4, the craft trimmer assembly 10 also includes a measuring arm 36 having a raised portion 38, with the measuring arm 36 being rotatably connected to the underside of the trimmer assembly 10 at a pivot region 40. The raised portion 38 of the measuring arm 36 is raised to a point such that the raised portion 38 is flush with the top surface of an interchangeable plate 32. As a result, when a sheet of paper or other material is placed on the craft trimmer assembly 10, the material will remain substantially flat and will not have any gaps between the material and the measuring arm 36 or the base 12. The raised surface 38 can also include a plurality of indicia thereon, including both English and metric indicia and other information. In one embodiment of the invention, the measuring arm 36 can also include a guide on the raised portion 38 in order to prevent potential misalignments and to keep large sheets of material square.

In a preferred embodiment of the invention, the craft trimmer assembly 10 includes a secondary measuring arm 44 that is rotatably coupled to the underside of the craft trimmer base 12. The secondary measuring arm 44 is sized to fit within a slot 46 on the underside of the craft trimmer base 12. The secondary measuring arm 44 can also include a plurality of indicia, such as English and metric measurements. The secondary measuring arm 44 also allows a user to trim materials from either side of the cartridge assembly 14.

The craft trimmer assembly 10 also includes a removable clamp 48 that fits within a plurality of slots 50 on the craft trimmer base 12. The removable clamp 48 serves to fix the position of the material to be cut, reducing the possibility that the material will move during the cutting process. The clamp 48 also serves to keep a user's hands away from sensitive materials, such as photographs, during a cutting operation, reducing the possibility that photographs will be damaged. The clamp 48 also aids in keeping materials archival safe for scrapbooking. If desired, the clamp 48 can also include a plurality of indicia to aid in measuring and aligning materials. In a preferred embodiment of the invention, the clamp 48 can include various markings for measurement or other purposes. Additionally, the clamp 48 may be transparent to improve the user's viewing and aligning of the material in question.

The craft trimmer base 12 also includes a grid 52 in the region adjacent to the cartridge assembly 14. This grid 52 serves to provide a mechanism for quickly and easily aligning the material that is to be cut and assuring that the cut is consistent and straight.

Optionally, the craft trimmer assembly 10 can also include a plurality of non-skid feet (not shown) coupled to the base 12. The non-skid feet serve to fix the position of the craft trimmer assembly 10 during operation.

It should be understood that the above description of the invention and the specific examples and embodiments, while indicating the preferred embodiments of the present invention, are given by demonstration and not limitation. Many changes and modifications within the scope of the present invention may therefore be made without departing from the spirit of the invention, and the invention includes all such changes and modifications.

What is claimed is:

1. A material cutting device, comprising:
a board upon which a material is to be cut, the board including a first surface upon which the material is placed;
a rail member operatively and rotatably connected to the board; and
a cartridge assembly slidably engaging the rail member and slidable along a cutting axis along the board, the cartridge assembly including:
a sleigh in slidable engagement with the rail member,
a cartridge removably connected to the sleigh, the cartridge being removable from the sleigh without the use of tools, and
a cutting element removably engaging the cartridge,
wherein a cutting surface of the cutting element aligns with the cutting axis of the board.

2. The material cutting device of claim 1, wherein the cartridge snap fits with the sleigh.

3. The material cutting device of claim 2, wherein the cartridge includes:
a cartridge casing;
an axle fixedly secured to the cutting element; and
a coupling member positioned between the axle and the cartridge casing, the coupling member acting against the axle to align the cutting element against the rail member.

4. The material cutting device of claim 3, wherein the cartridge includes a biasing member operatively connected to the cartridge casing, the biasing member biasing the cartridge away from the sleigh.

5. The material cutting device of claim 4, wherein the biasing member comprises a leaf spring.

6. The material cutting device of claim 1, further comprising a first measuring arm rotatably and operatively connected to the board, the first measuring arm rotatable about an axis substantially perpendicular to the cutting axis.

7. The material cutting device of claim 6, wherein the first measuring arm includes a first surface that is substantially coplanar with the first surface of the board.

8. The material cutting device of claim 6, further comprising a second measuring arm rotatably and operatively connected to the board, the second measuring arm rotatable about an axis substantially perpendicular to the cutting axis.

9. The material cutting device of claim 1, further comprising a material clamp removably and operatively connected to the board, wherein the material is secured between the material clamp and the board.

10. The material cutting device of claim 9, wherein the material clamp comprises a first end, a second end and an elongated portion between the first end and the second end, the elongated portion extending substantially parallel to the cutting axis, and wherein the first end and the second end each include means for removably securing the material clamp to the board.

11. The material cutting device of claim 1, further comprising a plurality of hinge members rotatably coupling the rail member to the cutting board, permitting the rail member to rotate about an axis substantially parallel to the cutting axis.

12. The material cutting device of claim 11, further comprising a cutting mat positioned within the board along the cutting axis.

13. A material cutting device, comprising:
a board upon which a material is to be cut, the board including a first surface upon which the material is placed;
a rail member operatively connected to the board, the rail member rotatable about an axis substantially perpendicular to a cutting axis along the board; and
a cartridge assembly slidably engaging the rail member and slidable along the cutting axis, the cartridge assembly including:
a sleigh in slidable engagement with the rail member,
a cartridge removably connected to the sleigh, the cartridge being removable from the sleigh without the use of tools,
a cutting element removably engaging the cartridge, and
a biasing member operatively connected to the cartridge, the biasing member biasing the cartridge away from the sleigh,
wherein a cutting surface of the cutting element aligns with the cutting axis of the board.

14. The material cutting device of claim 13, wherein the cartridge includes:
a cartridge casing;
an axle fixedly secured to the cutting element; and
a coupling member positioned between the axle and the cartridge casing, the coupling member acting against the axle to align the cutting element against the rail member.

15. The material cutting device of claim 14, wherein the cartridge snap fits with the sleigh.

16. The material cutting device of claim 14, wherein the biasing member comprises a leaf spring.

17. The material cutting device of claim 14, further comprising a cutting mat positioned within the board along the cutting axis.

18. The material cutting device of claim 14, further comprising a material clamp removably and operatively connected to the board, wherein the material is secured between the material clamp and the board.

19. The material cutting device of claim 18, wherein the material clamp comprises a first end, a second end and an elongated portion between the first end and the second end, the elongated portion extending substantially parallel to the cutting axis, and wherein the first end and the second end each include means for removably securing the material clamp to the board.

20. A cartridge assembly for use with a cutting device, comprising:
a sleigh adapted for slidable engagement with a rail member,
an upper casing member removably connected to the sleigh and being removable from the sleigh without the use of tools;
a biasing member acting against the sleigh to bias the upper casing member away from the sleigh;
a side casing member operatively connected to the upper casing member;
a cutting element removably and rotatably positioned between the upper casing member and the side casing member; and
means for removably securing the cutting element between the upper casing member and the side casing member.

21. The cartridge assembly of claim 20, wherein the securing means comprises:
an axle fixedly secured to the cutting element and operatively connected to the upper casing member and the side casing member; and
a coupler engaging and securing the axle to the side casing member.
